(19) United States
(12) Patent Application Publication
(10) Pub. No.: US 2023/0186053 A1
(43) Pub. Date: Jun. 15, 2023

(54) MACHINE-LEARNING BASED BEHAVIOR MODELING

(71) Applicant: SparkCognition, Inc., Austin, TX (US)

(72) Inventors: Sari Andoni, Austin, TC (US); Jimmie Goode, Austin, TX (US)

(21) Appl. No.: 17/643,457

(22) Filed: Dec. 9, 2021

(51) Int. Cl. G06N 3/04; G06N 3/08

(52) U.S. Cl. CPC G06N 3/0454; G06N 3/08

(57) ABSTRACT

A device includes one or more processors configured to process a portion of time-series data using a trained encoder network to generate a dimensionally reduced encoding of the portion of the time-series data. The one or more processors are further configured to process the dimensionally reduced encoding using a trained decoder network to determine decoder output data. The one or more processors are also configured to set parameters of a predictive machine-learning model based on the decoder output data, wherein the predictive machine-learning model is configured to, based on the parameters, determine a predicted future value of the time-series data.

### FIELD

The present disclosure is generally related to using trained machine-learning models to model behavior of a monitored system.

### BACKGROUND

Abnormal behavior can be detected using rules established by a subject matter expert or derived from physics-based models. However, it can be expensive and time consuming to properly establish and confirm such rules. The time and expense involved is compounded if the equipment or process being monitored has several normal operational states or if what behavior is considered normal changes from time to time. To illustrate, as equipment operates, the normal behavior of the equipment may change due to wear. It can be challenging to establish rules to monitor this type of gradual change in normal behavior. Further, in such situations, the equipment may occasionally undergo maintenance to offset the effects of the wear. Such maintenance can result in a sudden change in normal behavior, which is also challenging to monitor using established rules.

### SUMMARY

In some aspects, a device includes one or more processors configured to process a portion of time-series data using a trained encoder network to generate a dimensionally reduced encoding of the portion of the time-series data. The one or more processors are further configured to process the dimensionally reduced encoding using a trained decoder network to determine decoder output data. The one or more processors are also configured to set parameters of a predictive machine-learning model based on the decoder output data, wherein the predictive machine-learning model is configured to, based on the parameters, determine a predicted future value of the time-series data.

In some aspects, a method includes processing a portion of time-series data using a trained encoder network to generate a dimensionally reduced encoding of the portion of the time-series data. The method also includes processing the dimensionally reduced encoding using a trained decoder network to determine decoder output data. The method further includes setting parameters of a predictive machine-learning model based on the decoder output data. The predictive machine-learning model is configured to, based on the parameters, determine a predicted future value of the time-series data.

In some aspects, a computer-readable storage device stores instructions. The instructions, when executed by one or more processors, cause the one or more processors to perform operations including processing a portion of time-series data using a trained encoder network to generate a dimensionally reduced encoding of the portion of the time-series data. The operations also include processing the dimensionally reduced encoding using a trained decoder network to determine decoder output data. The operations further include setting parameters of a predictive machine-learning model based on the decoder output data. The predictive machine-learning model is configured to, based on the parameters, determine a predicted future value of the time-series data.

### BRIEF DESCRIPTION OF THE DRAWINGS

FIG. 1 is a diagram illustrating particular aspects of a system to monitor behavior of a monitored system in accordance with examples of the present disclosure.

FIG. 2 is a diagram illustrating further aspects of a system to monitor behavior of a monitored system in accordance with examples of the present disclosure.

FIG. 3 is a diagram illustrating particular aspects of operations to monitor behavior of a monitored system in accordance with further examples of the present disclosure.

FIG. 4 is a block diagram illustrating particular aspects of clustering to infer operating states of a monitored system in accordance with some examples of the present disclosure.

FIG. 5 is a flow chart of a first example of a method of behavior monitoring that may be implemented by the system of FIG. 1 or FIG. 2.

FIG. 6 is a flow chart of a second example of a method of behavior monitoring that may be implemented by the system of FIG. 1 or FIG. 2.

FIG. 7 is a flow chart of a third example of a method of behavior monitoring that may be implemented by the system of FIG. 1 or FIG. 2.

FIG. 8 illustrates an example of a computer system corresponding to, including, or included within the system of FIG. 1 or FIG. 2 according to particular implementations.

### DETAILED DESCRIPTION

Systems and methods are described that facilitate monitoring of operational states of a monitored system. As one example, the systems and methods disclosed herein enable monitoring of assets to detect anomalous behavior. Anomalous behavior may be indicative of an impending failure of the asset, and the systems and methods disclosed herein may facilitate early prediction of the impending failure so that maintenance or other actions can be taken.

The monitored system can include any mechanical, electrical, electronic, thermal, hydraulic, pneumatic, or nuclear device or combination of devices, so long as the device(s) can be characterized in terms of operating states. As non-limiting examples, the monitored system can include an industrial asset, such as production equipment, power generation or routing equipment, communications equipment, logistical equipment, etc. Many industrial assets operate via complex physical processes that dynamically transition between different operational states, which at various times may include normal and anomalous states. In some circumstances, an operator of a monitored system may be interested in detecting when the system transitions between operating states, detecting a current or past operating state of the system, determining whether a particular operating state is normal or anomalous, etc.

In some circumstances, so called “Normal Behavior Modeling” (NBM) can be used to detect anomalous operation of a monitored system. In one example of NBM, an autoencoder can be trained using only data representing operation in one or more “normal” (i.e., non-anomalous) operating states. In this example, after appropriate training, the autoencoder can be provided input data (e.g., multivariate time-series data) that represents operation of the monitored system. If the input data is similar to data used to train the autoencoder (e.g., if the input data represents one of the normal operating states), the autoencoder should be able to generate output data that reproduces the input data with reasonable accuracy. However, if the input data is not similar to data used to train the autoencoder (e.g., if the input data represents an anomalous operating state or a normal operating state that was not sufficiently represented in the training data), the autoencoder would not be expected to accurately reproduce the input data.

While autoencoder-based normal behavior modeling is very useful to detect anomalous operating states, it can be challenging to collect and prepare training data to train the autoencoder. For example, it can be difficult to separate data representing normal operating states from data representing abnormal operating states to generate training data. Additionally, it can be difficult to ensure that each normal operating state is sufficiently represented in the training data. Further, traditional autoencoders are feedforward networks, and as such, they may not account well for temporal or dynamic aspects of the data.

According to a particular aspect, two or more machine-learning models (e.g., neural networks) are used together to account for dynamic relationships among sensor data values representing operation of a monitored system. The sensor data values form a time series that includes multiple time windowed portions where each time windowed portion includes multivariate data (e.g., data from multiple sensors). In some implementations, a first machine-learning model evaluates input data based on multivariate sensor data from the monitored system to generate parameters for the second network. The second machine-learning model uses the parameters and input data to predict future values of the time-series data.

The parameters generated by the first machine-learning model are dependent on relationships among features of the time-series data. In some implementations, the first machine-learning model is a variational dimensional-reduction model that dimensionally reduces the input data and fits the dimensionally reduced input data to a probability distribution (e.g., a Gaussian distribution) to facilitate latent-space regularization and to facilitate separation of recognized operational states of the monitored system in the latent space. By way of illustration, in some implementations, the first machine-learning model is similar to a variational autoencoder except that, unlike an autoencoder, the first machine-learning model does not attempt to reproduce its input data. Rather, the first machine-learning model is trained to select appropriate parameters for the second machine-learning model.

The output of the first machine-learning model includes (or is mapped to) parameters that are used by the second machine-learning model to evaluate input data to predict a future value of the time series. For example, the parameters may include link weights of a neural network, may include kernel parameters of a convolutional neural network (CNN), or may include both link weights and kernel parameters.

Using two machine-learning models enables a monitoring system to perform forecasting in a manner that is state-dependent (e.g., is based on an inferred operating state of the monitored system), which may provide more accurate forecasting results when the monitored system is operating in any of several normal operating states. Additionally, in some implementations, the monitoring system can perform other operations, such as identifying the inferred operating state of the monitored system based on a dimensionally reduced encoding representing the input data. In such implementations, the inferred operating state can be used to improve situational awareness of operators associated with the monitored device. Additionally, or alternatively, the inferred operating state can be used to select a behavior model that can be used for anomaly detection (e.g., to determine whether the monitored system has deviated from the inferred operating state).

Used in this manner, the two machine-learning models may provide more accurate detection of changes or anomalies in an operating state of the monitored system. Additionally, the situational awareness of operators of the monitored system can be improved, such as by providing output identifying an inferred operating state of the monitored system along with alerting information if the monitored system deviates from a particular operating state.

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. Further the terms “comprise,” “comprises,” and “comprising” may be used interchangeably with “include,” “includes,” or “including.” Additionally, the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. Such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine-learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows — a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” As described further below, in transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Machine-learning models can be initialized from scratch (e.g., by a user, such as a data scientist) or using a guided process (e.g., using a template or previously built model). Initializing the model includes specifying parameters and hyperparameters of the model. “Hyperparameters” are characteristics of a model that are not modified during training, and “parameters” of the model are characteristics of the model that are modified during training. The term “hyperparameters” may also be used to refer to parameters of the training process itself, such as a learning rate of the training process. In some examples, the hyperparameters of the model are specified based on the task the model is being created for, such as the type of data the model is to use, the goal of the model (e.g., classification, regression, anomaly detection), etc. The hyperparameters may also be specified based on other design goals associated with the model, such as a memory footprint limit, where and when the model is to be used, etc.

Model type and model architecture of a model illustrate a distinction between model generation and model training. The model type of a model, the model architecture of the model, or both, can be specified by a user or can be automatically determined by a computing device. However, neither the model type nor the model architecture of a particular model is changed during training of the particular model. Thus, the model type and model architecture are hyperparameters of the model and specifying the model type and model architecture is an aspect of model generation (rather than an aspect of model training). In this context, a “model type” refers to the specific type or sub-type of the machine-learning model. As noted above, examples of machine-learning model types include, without limitation, perceptrons, neural networks, support vector machines, regression models, decision trees, Bayesian models, Boltzmann machines, adaptive neuro-fuzzy inference systems, as well as combinations, ensembles and variants of these and other types of models. In this context, “model architecture” (or simply “architecture”) refers to the number and arrangement of model components, such as nodes or layers, of a model, and which model components provide data to or receive data from other model components. As a non-limiting example, the architecture of a neural network may be specified in terms of nodes and links. To illustrate, a neural network architecture may specify the number of nodes in an input layer of the neural network, the number of hidden layers of the neural network, the number of nodes in each hidden layer, the number of nodes of an output layer, and which nodes are connected to other nodes (e.g., to provide input or receive output). As another non-limiting example, the architecture of a neural network may be specified in terms of layers. To illustrate, the neural network architecture may specify the number and arrangement of specific types of functional layers, such as long-short-term memory (LSTM) layers, fully connected (FC) layers, convolution layers, etc. While the architecture of a neural network implicitly or explicitly describes links between nodes or layers, the architecture does not specify link weights. Rather, link weights are parameters of a model (rather than hyperparameters of the model) and are modified during training of the model.

In many implementations, a data scientist selects the model type before training begins. However, in some implementations, a user may specify one or more goals (e.g., classification or regression), and automated tools may select one or more model types that are compatible with the specified goal(s). In such implementations, more than one model type may be selected, and one or more models of each selected model type can be generated and trained. A best performing model (based on specified criteria) can be selected from among the models representing the various model types. Note that in this process, no particular model type is specified in advance by the user, yet the models are trained according to their respective model types. Thus, the model type of any particular model does not change during training.

Similarly, in some implementations, the model architecture is specified in advance (e.g., by a data scientist); whereas in other implementations, a process that both generates and trains a model is used. Generating (or generating and training) the model using one or more machine-learning techniques is referred to herein as “automated model building”. In one example of automated model building, an initial set of candidate models is selected or generated, and then one or more of the candidate models are trained and evaluated. In some implementations, after one or more rounds of changing hyperparameters and/or parameters of the candidate model(s), one or more of the candidate models may be selected for deployment (e.g., for use in a runtime phase).

Certain aspects of an automated model building process may be defined in advance (e.g., based on user settings, default values, or heuristic analysis of a training data set) and other aspects of the automated model building process may be determined using a randomized process. For example, the architectures of one or more models of the initial set of models can be determined randomly within predefined limits. As another example, a termination condition may be specified by the user or based on configurations settings. The termination condition indicates when the automated model building process should stop. To illustrate, a termination condition may indicate a maximum number of iterations of the automated model building process, in which case the automated model building process stops when an iteration counter reaches a specified value. As another illustrative example, a termination condition may indicate that the automated model building process should stop when a reliability metric associated with a particular model satisfies a threshold. As yet another illustrative example, a termination condition may indicate that the automated model building process should stop if a metric that indicates improvement of one or more models over time (e.g., between iterations) satisfies a threshold. In some implementations, multiple termination conditions, such as an iteration count condition, a time limit condition, and a rate of improvement condition can be specified, and the automated model building process can stop when one or more of these conditions is satisfied.

Another example of training a previously generated model is transfer learning. “Transfer learning” refers to initializing a model for a particular data set using a model that was trained using a different data set. For example, a “general purpose” model can be trained to detect anomalies in vibration data associated with a variety of types of rotary equipment, and the general-purpose model can be used as the starting point to train a model for one or more specific types of rotary equipment, such as a first model for generators and a second model for pumps. As another example, a general-purpose natural-language processing model can be trained using a large selection of natural-language text in one or more target languages. In this example, the general-purpose natural-language processing model can be used as a starting point to train one or more models for specific natural-language processing tasks, such as translation between two languages, question answering, or classifying the subject matter of documents. Often, transfer learning can converge to a useful model more quickly than building and training the model from scratch.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

As another example, to use supervised training to train a model to perform a classification task, each data element of a training data set may be labeled to indicate a category or categories to which the data element belongs. In this example, during the creation/training phase, data elements are input to the model being trained, and the model generates output indicating categories to which the model assigns the data elements. The category labels associated with the data elements are compared to the categories assigned by the model. The computer modifies the model until the model accurately and reliably (e.g., within some specified criteria) assigns the correct labels to the data elements. In this example, the model can subsequently be used (in a runtime phase) to receive unknown (e.g., unlabeled) data elements, and assign labels to the unknown data elements. In an unsupervised training scenario, the labels may be omitted. During the creation/training phase, model parameters may be tuned by the training algorithm in use such that the during the runtime phase, the model is configured to determine which of multiple unlabeled “clusters” an input data sample is most likely to belong to.

As another example, to train a model to perform a regression task, during the creation/training phase, one or more data elements of the training data are input to the model being trained, and the model generates output indicating a predicted value of one or more other data elements of the training data. The predicted values of the training data are compared to corresponding actual values of the training data, and the computer modifies the model until the model accurately and reliably (e.g., within some specified criteria) predicts values of the training data. In this example, the model can subsequently be used (in a runtime phase) to receive data elements and predict values that have not been received. To illustrate, the model can analyze time-series data, in which case, the model can predict one or more future values of the time series based on one or more prior values of the time series.

In some aspects, the output of a model can be subjected to further analysis operations to generate a desired result. To illustrate, in response to particular input data, a classification model (e.g., a model trained to perform classification tasks) may generate output including an array of classification scores, such as one score per classification category that the model is trained to assign. Each score is indicative of a likelihood (based on the model's analysis) that the particular input data should be assigned to the respective category. In this illustrative example, the output of the model may be subjected to a softmax operation to convert the output to a probability distribution indicating, for each category label, a probability that the input data should be assigned the corresponding label. In some implementations, the probability distribution may be further processed to generate a one-hot encoded array. In other examples, other operations that retain one or more category labels and a likelihood value associated with each of the one or more category labels can be used.

One example of a machine-learning model is an autoencoder. An autoencoder is a particular type of neural network that is trained to receive multivariate input data, to process at least a subset of the multivariate input data via one or more hidden layers, and to perform operations to reconstruct the multivariate input data using output of the hidden layers. If at least one hidden layer of an autoencoder includes fewer nodes than the input layer of the autoencoder, the autoencoder may be considered a type of dimensional-reduction model. If each of the one or more hidden layer(s) of the autoencoder includes more nodes than the input layer of the autoencoder, the autoencoder may be referred to herein as a denoising model or a sparse model, as explained further below.

For dimensional reduction type autoencoders, the hidden layer with the fewest nodes is referred to as the latent-space layer. Thus, a dimensional reduction autoencoder is trained to receive multivariate input data, to perform operations to dimensionally reduce the multivariate input data to generate latent-space data in the latent-space layer, and to perform operations to reconstruct the multivariate input data using the latent-space data.

As used herein, “dimensional reduction” refers to representing n values of multivariate input data using z values (e.g., as latent-space data), where n and z are integers and z is less than n. Often, in an autoencoder the z values of the latent-space data are then dimensionally expanded to generate n values of output data. In some special cases, a dimensional-reduction model may generate m values of output data, where m is an integer that is not equal to n. As used herein, such special cases are still referred to as autoencoders as long as the data values represented by the input data are a subset of the data values represented by the output data or the data values represented by the output data are a subset of the data values represented by the input data. For example, if the multivariate input data includes 10 sensor data values from 10 sensors, and the dimensional-reduction model is trained to generate output data representing only 5 sensor data values corresponding to 5 of the 10 sensors, then the dimensional-reduction model is referred to herein as an autoencoder. As another example, if the multivariate input data includes 10 sensor data values from 10 sensors, and the dimensional-reduction model is trained to generate output data representing 10 sensor data values corresponding to the 10 sensors and to generate a variance value (or other statistical metric) for each of the sensor data values, then the dimensional-reduction model is also referred to herein as an autoencoder (e.g., a variational autoencoder). If a model performs dimensional reduction but does not attempt to recreate the input data, the model is referred to herein merely as a dimensional-reduction model.

Denoising autoencoders and sparse autoencoders do not include a latent-space layer to force changes in the input data. An autoencoder without a latent-space layer could simply pass the input data, unchanged, to the output nodes resulting in a model with little utility. Denoising autoencoders avoid this result by zeroing out a subset of values of an input data set while training the denoising autoencoder to reproduce the entire input data set at the output nodes. Put another way, the denoising autoencoder is trained to reproduce an entire input data sample based on input data that includes less than the entire input data sample. For example, during training of a denoising autoencoder that includes 10 nodes in the input layer and 10 nodes in the output layer, a single set of input data values includes 10 data values; however, only a subset of the 10 data values (e.g., between 2 and 9 data values) are provided to the input layer. The remaining data values are zeroed out. To illustrate, out of 10 data values, 7 data values may be provided to a respective 7 nodes of the input layer, and zero values may be provided to the other 3 nodes of the input layer. Fitness of the denoising autoencoder is evaluated based on how well the output layer reproduces all 10 data values of the set of input data values, and during training, parameters of the denoising autoencoder are modified over multiple iterations to improve its fitness.

Sparse autoencoders prevent passing the input data unchanged to the output nodes by selectively activating a subset of nodes of one or more of the hidden layers of the sparse autoencoder. For example, if a particular hidden layer has 10 nodes, only 3 nodes may be activated for particular data. The sparse autoencoder is trained such that which nodes are activated is data dependent. For example, for a first data sample, 3 nodes of the particular hidden layer may be activated, whereas for a second data sample, 5 nodes of the particular hidden layer may be activated.

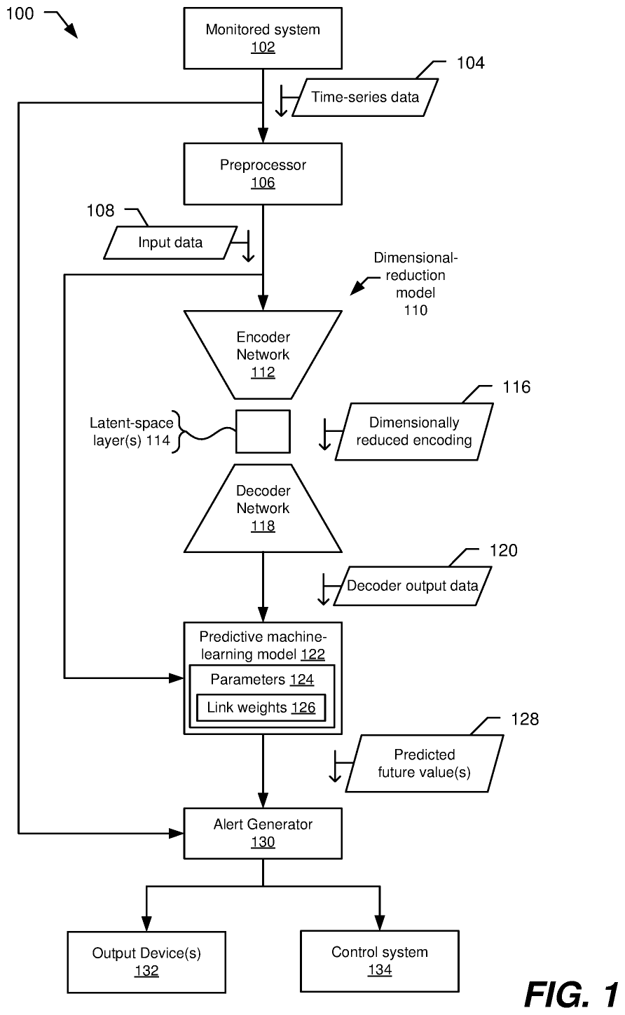

FIG. 1 is a diagram illustrating particular aspects of a system 100 to monitor behavior of a monitored system 102 in accordance with some examples of the present disclosure. In the example illustrated in FIG. 1, the system 100 includes various components. In some implementations, one or more of the components illustrated in FIG. 1 correspond to instructions that are executable by one or more processors executing instructions to obtain data from the monitored system 102, to evaluate the data (and possibly other data) using various machine-learning models to determine whether the monitored system 102 is operating as expected, and to generate output based on the evaluation. The output may include, for example, an informational display provided to a user (e.g., an operator associated with the monitored system), a control signal provided to a control system associated with the monitored system 102, or both.

The monitored system 102 of FIG. 1 can include any mechanical, electrical, electronic, thermal, hydraulic, pneumatic, or nuclear device or combination of devices. During operation of the monitored system 102, sensors associated with (e.g., embedded with, coupled to, or both) the monitored system 102 generate time-series data 104 representative of operation of the monitored system 102. Non-limiting examples of the time-series data 104 include a time series of temperature measurement values, a time series of vibration measurement values, a time series of voltage measurement values, a time series of amperage measurement values, a time series of rotation rate measurement values, a time series of frequency measurement values, a time series of packet loss rate values, a time series of data error values, a time series of pressure measurement values, measurements of other mechanical, electromechanical, electrical, or electronic metrics, or a combination thereof.

In a particular aspect, the time-series data 104 is multivariate (e.g., includes values representing output of two or more sensors). For example, the time-series data 104 may include data generated by multiple sensors of the same type or of different types. As an example of sensor data from multiple sensors of the same type, the time-series data 104 may include multiple time series of temperature values from temperature sensors associated with different locations of the monitored system 102. As an example of sensor data from multiple sensors of different types, the time-series data 104 may include one or more time series of temperature values from one or more temperature sensors associated with the monitored system 102 and one or more time series of rotation rate values from one or more rotation sensors associated with the monitored system 102. A time series representing values of a particular variable (e.g., values from a particular sensor) is also referred to herein as a “feature” or as “feature data”.

In FIG. 1, a preprocessor 106 receives the time-series data 104 and performs various operations to modify and/or supplement the time-series data 104 to generate input data 108 for evaluation by various machine-learning models. Operations performed by the preprocessor 106 include, for example, filtering operations to remove outlying data samples, to reduce or limit bias (e.g., due to sensor drift or predictable variations), to remove sets of samples associated with particular events (such as data samples during a start-up period or during a known failure event), denoising, etc. In some implementations, the preprocessor 106 may also, or in the alternative, add to the time-series data 104, such as imputation to fill in estimated values for missing data samples or to equalize sampling rates of two or more sensors. In some implementations, the preprocessor 106 may also, or in the alternative, scale or normalize values of the time-series data 104. In some implementations, the preprocessor 106 may also, or in the alternative, determine new data values based on data value(s) in the time-series data 104. To illustrate, the time-series data 104 may include an analog representation of audio data, and the preprocessor 106 may sample the audio data and perform a time-domain to frequency-domain transformation (e.g., a Fast Fourier Transform) to generate a time series of frequency-domain spectra representing the audio data.

The preprocessor 106 may also, or alternatively, format the time-series data to generate the input data 108. For example, the processor 106 may generate an array of data values based on the time-series data 104. In this example, the array of data values may include values of the time-series data 104 and/or data values derived from the time-series data 104 via various preprocessing operations. To illustrate, in a particular implementation, each row of the array of data values represents a time step and each column of the array of values represents a particular value included in or derived from the time-series data 104.

In the example, illustrated in FIG. 1, the input data 108 representing a portion of the time-series data 104 is provided as input to using a trained encoder network (e.g., encoder network 112 of FIG. 1) of a dimensional-reduction model 110. The encoder network 112 is configured to generate a dimensionally reduced encoding 116 based on the input data 108 representing the portion of the time-series data 104. For example, the encoder network 112 may include a plurality of layers (e.g., fully connected layers, convolutional layers, etc.) that reduce the dimensionality of the multivariate input data 108 to generate the dimensionally reduced encoding 116 at one or more latent-space layers 114 (e.g., bottleneck layers) of the dimensional-reduction model 110.

In FIG. 1, the dimensionally reduced encoding 116 is provided as input to a trained decoder network (e.g., decoder network 118 of FIG. 1) to determine decoder output data 120. In a particular aspect, the decoder network 118 is configured to generate output (e.g., the decoder output data 120) that represents parameters to be used by a predictive machine-learning model 122. As a specific example, the decoder output data 120 may include values of parameters 124 of the predictive machine-learning model 122. To illustrate, the predictive machine-learning model 122 may include a neural network, and the parameters 124 may include or correspond to link weights 126 of the neural network.

In the example illustrated in FIG. 1, after the parameters 124 of the predictive machine-learning model 122 are set based on the decoder output data 120, the input data 108 is provided as input to the predictive machine-learning model 122. The predictive machine-learning model 122 processes the input data 108 (based on the parameters 124) to determine one or more predicted future values 128 of the time-series data 104. For example, the predicted future value(s) 128 may indicate predicted values of one or more variables of time-series data 104. In this context, “future” refers to time steps of the time-series data 104, and not necessarily to objective clock time. To illustrate, particular input data 108 provided to the predictive machine-learning model 122 represents a particular time step or time range of data values of the time-series data 104, and a future value refers to a value of a time step or time range subsequent to the particular time step or time range represented by the input data 108.

The predicted future value(s) 128 are provided as input to an alert generator 130. The alert generator 130 is configured to receive a subsequent portion of the time-series data 104 and to compare the predicted future value(s) 128 with corresponding future value(s) of the subsequent portion of the time-series data 104 to determine whether the monitored system 102 has deviated from a particular operational state. As one example, the predicted future value(s) 128 may include a predicted future temperature value, which the alert generator 130 may compare to an actual future temperature value from the time-series data 104. To illustrate, when there is significant deviation (e.g., greater than a threshold) between the predicted future value(s) 128 and the corresponding future value(s) of the time-series data 104, the alert generator 130 may determine that the monitored system 102 has deviated from an expected operational state.

In a particular aspect, when the alert generator 130 determines that the monitored system 102 has deviated from the particular operational state, the alert generator 130 provides output to one or more output devices 132, to a control system 134 associated with the monitored system 102, or both. For example, the output to the output device(s) 132 may include an alert to notify a user (e.g., an operator) of the deviation of the operational state of the monitored system 102. Examples of such notifications include, without limitation, audible signals (e.g., sirens, bells, etc.), graphical user interfaces, graphical components in a display, visual signals (e.g., lights), haptic signals (e.g., vibrations), or other user perceivable indications. In a particular aspect, signals sent to the control system 134 may cause the control system 134 to send control signals to the monitored system 102 to modify operation of the monitored system 102. To illustrate, the control signals may cause the monitored system 102 to shut down, to change a set point, to restart, etc. In some implementations, signals sent to the control system 134 may cause the control system 134 to schedule maintenance, inspection, or testing of the monitored system 102.

Using two or more machine-learning models enables the system 100 to perform forecasting in a manner that is state-dependent (e.g., is based on an inferred operating state of the monitored system 102), which may provide more accurate forecasting results when the monitored system 102 is operating in any of several normal operating states. Additionally, in some implementations, the system 100 can perform other operations, such as identifying the inferred operating state of the monitored system 102 based on a dimensionally reduced representation of the input data 108. In such implementations, the inferred operating state can be used to improve situational awareness of operators associated with the monitored system 102. Additionally, or alternatively, the inferred operating state can be used to select a behavior model (e.g., the predictive machine-learning model 122, the alert generator 130, or both) that can be used for anomaly detection (e.g., to determine whether the monitored system 102 has deviated from the inferred operating state).

Thus, the system 100 may provide more accurate detection of changes or anomalies in an operating state of the monitored system 102. Additionally, the situational awareness of operators of the monitored system 102 can be improved, such as by providing output identifying an inferred operating state of the monitored system 102 along with alerting information if the monitored system 102 deviates from a particular operating state.

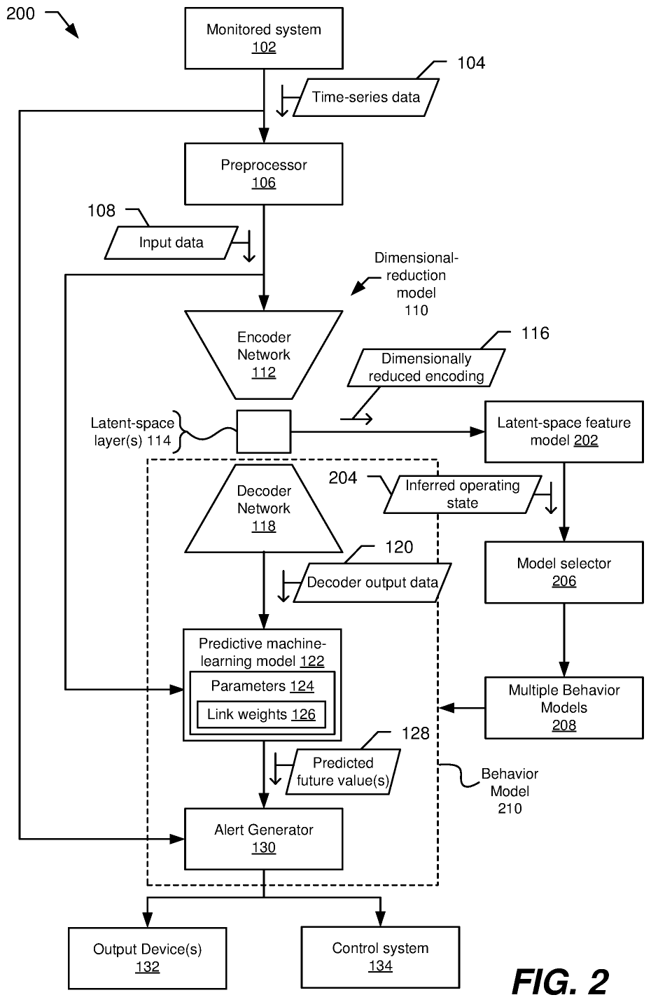

FIG. 2 is a diagram illustrating further aspects of a system 200 to monitor behavior of a monitored system 102 in accordance with examples of the present disclosure. In the example illustrated in FIG. 2, the system 200 includes each of the features described above with reference to the system 100 of FIG. 1. For example, the system 200 includes the monitored system 102, the preprocessor 106, the dimensional-reduction model 110, the predictive machine-learning model 122, the alert generator 130, the output device(s) 132, and the control system 134, each of which is configured to operate as described with reference to FIG. 1. The system 200 of FIG. 2 also includes other components that interact with the system 100 to provide additional functionality. To illustrate, the system 200 includes a latent-space feature model 202, a model selector 206, and multiple behavior models 208, as described further below.

In FIG. 2, the latent-space feature model 202 is configured to infer an operating state (e.g., inferred operating state 204) of the monitored system 102 based on the dimensionally reduced encoding 116. In some implementations, the latent-space feature model 202 also generates a confidence value associated with the inferred operating state 204. In a particular implementation, the latent-space feature model 202 uses a clustering approach to infer the operating state of the monitored system 102. For example, during training of the latent-space feature model 202, dimensionally reduced encodings corresponding to recognized (e.g., labeled) operating states of the monitored system 102 can be mapped into a latent space, and clustering can be performed to identify regions or boundaries of regions in the latent space that correspond to each recognized operating state. In some implementations, the dimensionally reduced encoding 116 includes values of latent-space features, and the encoder network 112 determines the value of a particular latent-space feature based, at least in part, on a probability distribution associated with the particular latent-space feature. In some implementations, the encoder network 112 fits the values the latent-space features to one or more probability distributions (e.g., Gaussian distributions) to facilitate latent-space regularization and to facilitate separation of recognized operational states of the monitored system in the latent space.

As a result of such training, the latent-space feature model 202 is able to distinguish among recognized operating states of the monitored system 102 by comparing locations in the latent space. For example, the dimensionally reduced encoding 116 represents a particular location in the latent space. In this example, the latent-space feature model 202 is configured to compare locations in a latent space to determine whether the location of the dimensionally reduced encoding 116 is similar to (as explained further below) one or more locations in the latent space that are associated with detectable (e.g., recognized) operating states.

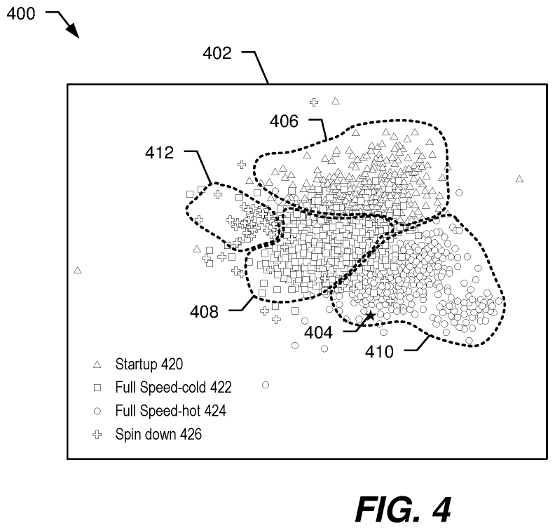

The locations in the latent space that are associated with detectable operating states correspond to sets of points, representative points, boundaries of regions, or a combination thereof. For example, FIG. 4 illustrates an example 400 of a two-dimensional projection of a multivariate latent space 402 and a plurality of points. In FIG. 4, each white filled point corresponds to a location in the latent space 402 of a dimensionally reduced encoding associated with a known (e.g., labeled) operating state, and the black filled point 404 corresponds to a location in the latent space 402 of the dimensionally reduced encoding 116 generated based on particular input data 108 representing operation of the monitored system 102. For purposes of illustration, in FIG. 4, triangular points correspond to locations in the latent space 402 of dimensionally reduced encodings associated with a startup operating state 420, square points correspond to locations in the latent space 402 of dimensionally reduced encodings associated with a full speed-cold operating state 422, circular points correspond to locations in the latent space 402 of dimensionally reduced encodings associated with a full speed-hot operating state 424, and cruciform points correspond to locations in the latent space 402 of dimensionally reduced encodings associated with a spin down operating state 426. Although the points illustrated in FIG. 4 correspond to four detectable operating states, this is merely for illustration. In other implementations, the latent-space feature model 202 is trained to detect fewer than four distinct operating states, more than four distinct operating states, and/or different operating states than those illustrated.

In some implementations, a region of the latent space 402 that corresponds to a detectable operating state may be associated with a set of points, each of which represents a dimensionally reduced encoding associated with a known (e.g. labeled) operating state. For example, at runtime, the latent-space feature model 202 may compare the location 404 of the dimensionally reduced encoding 116 to locations of one or more nearest neighbor points in the latent space 402. In this example, each nearest neighbor point represents a corresponding detectable operating state, and the latent-space feature model 202 determines whether the dimensionally reduced encoding 116 represents operation of the monitored system 102 in a particular detectable operating state based on a distance (e.g., a cosine distance) between the location 404 of the dimensionally reduced encoding 116 and the location(s) of nearest neighbor point(s) associated with the particular detectable operating state. To illustrate, the dimensionally reduced encoding 116 may be determined to represent operation of the monitored system 102 in a first detectable operating state (e.g., the full speed-hot operating state 424) if the location 404 of the dimensionally reduced encoding 116 is within a threshold distance of one or more nearest neighbor points associated with the first detectable operating state. As another illustrative example, the dimensionally reduced encoding 116 may be determined to represent operation of the monitored system 102 in the first detectable operating state if a threshold proportion of the nearest neighbor points of the location of the dimensionally reduced encoding 116 are associated with the first detectable operating state. For example, if more than 80% (or some other proportion, such as 100%) of a sampled set of nearest neighbor points are associated with the first detectable operating state, the dimensionally reduced encoding 116 may be determined to represent operation of the monitored system 102 in the first detectable operating state.

In some implementations, a region of the latent space 402 that corresponds to a detectable operating state may be associated with a representative point. To illustrate, the representative point for a particular detectable operating state may be a centroid of points associated with the particular detectable operating state. In such implementations, the latent-space feature model 202 determines whether the dimensionally reduced encoding 116 represents operation of the monitored system 102 in a particular detectable operating state based on a distance (e.g., a cosine distance) between the location 404 of the dimensionally reduced encoding 116 and the location(s) of a representative point associated with the particular detectable operating state. To illustrate, the dimensionally reduced encoding 116 may be determined to represent operation of the monitored system 102 in a first detectable operating state (e.g., the full speed-hot operating state 424) if the location 404 of the dimensionally reduced encoding 116 is within a threshold distance of a centroid of the points associated with the first detectable operating state. In some such implementations, the threshold distance may be determined based on dispersion of the points associated with the first detectable operating state. To illustrate, the threshold distance may be selected such that 80% of the points associated with the first detectable operating state are within the threshold distance of the centroid of the first detectable operating state.

In some implementations, a region of the latent space 402 that corresponds to a detectable operating state may be associated with a boundary. For example, in FIG. 4, a boundary 406 represents a region of the latent space 402 associated with the startup operating state 420, a boundary 408 represents a region of the latent space 402 associated with the full speed-cold operating state 422, a boundary 410 represents a region of the latent space 402 associated with the full speed-hot operating state 424, and a boundary 412 represents a region of the latent space 402 associated with the spin down operating state 426. The boundaries may be determined during training of the latent-space feature model 202. For example, the boundaries may be established based on density-based clustering of training data points in the latent space. To illustrate, each may be determined as a boundary of a cluster of points representing a respective detectable operating state. In such implementations, the latent-space feature model 202 determines whether the dimensionally reduced encoding 116 represents operation of the monitored system 102 in a particular detectable operating state based on a position of the location 404 of the dimensionally reduced encoding 116 relative to one or more boundaries. To illustrate, the dimensionally reduced encoding 116 may be determined to represent operation of the monitored system 102 in a first detectable operating state (e.g., the full speed-hot operating state 424) if the location 404 of the dimensionally reduced encoding 116 is within the boundary 410 associated with the first detectable operating state.

Returning to FIG. 2, in a particular implementation, information descriptive of the inferred operating state 204 is provided as output to a user, such as an operator associated with the monitored system 102. For example, the information descriptive of the inferred operating state 204 may be provided to the output device(s) 132 to improve the user's situational awareness regarding the current operating state of the monitored system 102. In some implementations, a confidence value associated with the inferred operating state 204 is also provided to the user.

Additionally, or alternatively, in some implementations, the information descriptive of the inferred operating state 204 is provided to the control system 134. In such implementations, the control system 134 may select particular control actions or control laws based on the information descriptive of the inferred operating state 204. To illustrate, a first control signal gain may be used when the monitored system 102 is operating in a first operating state (e.g., the full speed-cold operating state of FIG. 4) and a second control signal gain may be used when the monitored system 102 is operating in a second operating state (e.g., the full speed-hot operating state of FIG. 4).

Additionally, or alternatively, in some implementations, the information descriptive of the inferred operating state 204 is provided to a model selector 206. The model selector 206 is configured to select a particular behavior model 210 from among multiple behavior models 208 based on the inferred operating state 204. The multiple behavior models 208 may include, for example, a first behavior model that is associated with one or more first operating states of the monitored system 102 and a second behavior model that is associated with one or more second operating states of the monitored system 102. To illustrate, the first behavior model may be associated with start-up operating states and the second behavior model may be associated with steady state (e.g., not start up and not shut down) operating states.

In a particular aspect, each behavior model of the multiple behavior models 208 includes a decoder network 118, a predictive machine-learning model 122, an alert generator 130, or both. In a particular aspect, when a behavior model of the multiple behavior models 208 includes a predictive machine-learning model 122, the predictive machine-learning model 122 may specify an architecture and or model type of the predictive machine-learning model 122, and the parameters 124 of the predictive machine-learning model 122 may be set or adjusted based on the decoder output data 120. In some implementations, a behavior model of the multiple behavior models 208 includes a predictive machine-learning model 122 and a decoder network 118, where the decoder network 118 is configured and trained to provide parameters 124 for the predictive machine-learning model 122. In some implementations, the same decoder network 118 and predictive machine-learning model 122 are used for each operating state of the monitored system 102, and the multiple behavior models 208 include different alert generators 130 that are to be used for different operating states. To illustrate, an alert generator 130 used for steady-state operations may be different from an alert generator 130 used for start-up or shutdown operations.

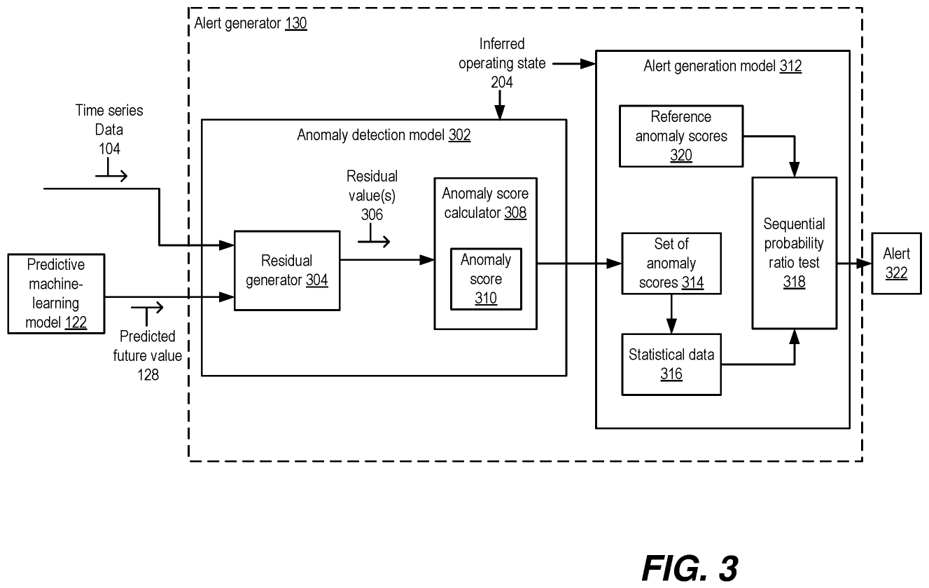

FIG. 3 is a diagram illustrating particular aspects of operations to monitor behavior of a monitored system in accordance with further examples of the present disclosure. In particular, FIG. 3 illustrates aspects of an example of the alert generator 130 of FIGS. 1 and 2.

In the example illustrated in FIG. 3, the alert generator 130 is configured to receive the time-series data 104 of FIGS. 1 and 2. In some examples, the alert generator 130 may alternatively (or additionally) receive the input data 108 based on the time-series data 104. The alert generator 130 is also configured to receive the predicted future value(s) 128 from the predictive machine-learning model 122.

In FIG. 3 the alert generator 130 includes an anomaly detection model 302 and an alert generation model 312. The anomaly detection model 302 includes a residual generator 304 and an anomaly score calculator 308. The residual generator 304 is configured to compare a value of the predicted future values 128 to a corresponding value of the time-series data 104 to determine a residual value 306. In some implementations, the residual generator 304 may compare each of two or more of the predicted future values 128 to corresponding values of the time-series data 104 to determine more than one residual value 306.

In a particular aspect, the predictive machine-learning model 122 is trained to receive values of one or more features of the time-series data 104 (or of the input data 108) and to generate as output predicted future values 128 of the same one or more features. For example, the received features may be denoted as zₜ for a particular timeframe (t), and the predicted future values 128 may be denoted as z′ₜ₊₁ for a future timeframe (t+1), where ′ indicates that the value is predicted. In this example, the predicted future value(s) 128 represent values of features that are among the input to the predictive machine-learning model 122. To illustrate, the time-series data 104 may include readings from one or more sensors for the particular timeframe (t), and the predicted future value(s) 128 include estimated values of the readings from the one or more sensors for a different timeframe (t+1). In such examples, the dimensional-reduction model 110 and predictive machine-learning model 122 are trained together to reduce or minimize a prediction error between the model input (zₜ₊₁) and the model output (z′ₜ₊₁) when the time-series data 104 represents a normal or recognized operation condition associated with a monitored system 102.

The residual generator 304 is configured to generate a residual value (r) according to r=z′ₜ₊₁−zₜ₊₁, where z′ₜ₊₁ is an estimated value (e.g., a value from the predicted future values 128) based on data for a prior time step (t), and zₜ₊₁ is the actual value (e.g., a value from the time-series data 104) of z for a later time step (t+1). Generally, the time-series data 104 and the predicted future value(s) 128 are multivariate. For example, each time windowed portion of the time-series data 104 includes multiple values, with each value representing a different feature, such as a sensor reading. When the time-series data 104 and the predicted future value(s) 128 are multivariate, the residual generator 304 determines multiple residual values for each frame (e.g., for each time windowed portion of the time-series data 104).

The anomaly score calculator 308 is configured to determine an anomaly score 310 for each sample time frame (e.g., each time windowed portion of the time-series data 104) based on the residual value(s) 306. The anomaly score 222 is provided to the alert generation model 312. In some implementations, the residual value(s) 306 are used as the anomaly score 310. In some implementations, the normalized or otherwise adjusted values of the residual value(s) 306 are used as the anomaly score 310. In some implementations, the type of anomaly score 310 calculated or the method for calculating the anomaly score depends on the inferred operating state 204. For example, the anomaly score calculator 308 may determine the anomaly score 310 using only a subset of the residual value(s) 306 (corresponding to particular features of the time-series data 104) when the inferred operating state 204 has a first value and may use all of the residual value(s) 306 to determine the anomaly score 310 when the inferred operating state 204 has a second value.

In some implementations, the anomaly score 310 is calculated based on a sliding aggregation window of residual values for different time periods. As a non-limiting example, the anomaly score 310 may be determined as an L2-norm of a rolling mean of the residual values 306, where the rolling mean is determined based on the sliding aggregation window. In another non-limiting example, the anomaly score 310 is determined as a rolling mean of L2-norms of the residual values 306.

In a particular aspect, the anomaly detection model 302 is trained based on relationships (which may be nonlinear) between variables of training data. When the relationships between variables are similar in the training data set and in the time-series data 104, the residual values 306 will be small and therefore the anomaly score 310 will also be small. In contrast, the anomaly score 310 will be large when at least one feature is poorly reconstructed or poorly estimated. This situation is likely to occur when the relationship of that feature with other features of the time-series data 104 has changed relative to the training data set.

The alert generation model 312 evaluates the anomaly score 310 to determine whether to generate an alert 322. As one example, the alert generation model 312 compares one or more values of the anomaly score 310 to one or more respective thresholds to determine whether to generate the alert 322. The respective threshold(s) may be preconfigured or determined dynamically (e.g., based on one or more values of the time-series data 104). In some implementations, one or more of the respective threshold(s) are selected based on the inferred operating state 204. In a particular implementation, the alert generation model 312 determines whether to generate the alert 322 using a sequential probability ratio test (SPRT) 318 based on the current value(s) of the anomaly score 310 and historical anomaly score values (e.g., based on the historical sensor data).

As one example, in FIG. 3, the alert generation model 312 accumulates a set of anomaly scores 314 representing multiple sample time frames and uses the set of anomaly scores 314 to generate statistical data 316. In the illustrated example, the alert generation model 312 uses the statistical data 316 to perform the sequential probability ratio test 318 to selectively generate the alert 322. For example, the sequential probability ratio test 318 is a sequential hypothesis test that provides continuous validations or refutations of the hypothesis that the monitored system 102 is behaving abnormally, by determining whether the anomaly score 310 continues to follow, or no longer follows, normal behavior statistics of reference anomaly scores 320. In some implementations, the reference anomaly scores 320 include data indicative of a distribution of reference anomaly scores (e.g., mean and variance) instead of, or in addition to, the actual values of the reference anomaly scores. In some implementations, the alert generation model 312 includes multiple sets of reference anomaly scores 320, and the particular set of reference anomaly scores 320 used for the sequential probability ratio test 318 is selected based on the inferred operating state 204. The sequential probability ratio test 318 provides an early detection mechanism and supports tolerance specifications for false positives and false negatives.

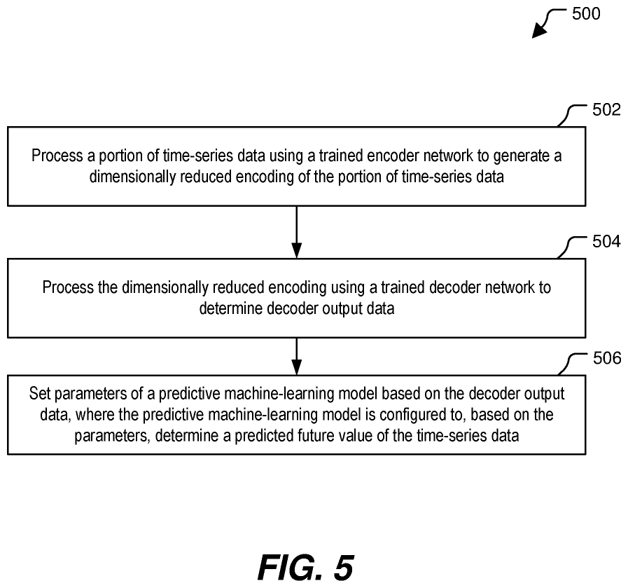

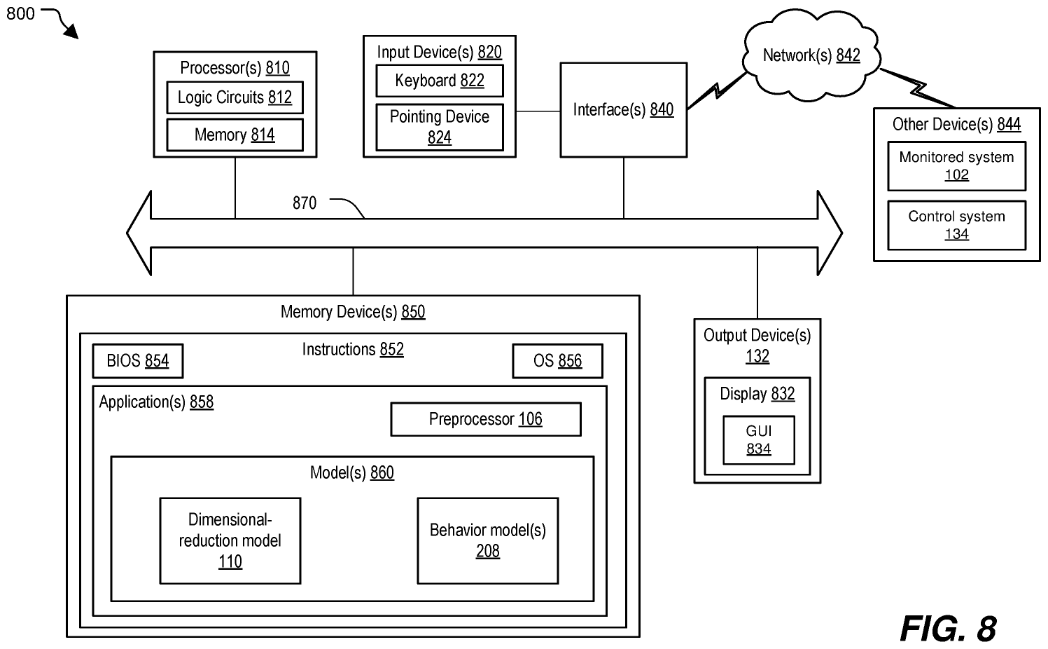

FIG. 5 is a flow chart of a first example of a method 500 of behavior monitoring that may be implemented by the system of FIG. 1 or FIG. 2. For example, one or more operations described with reference to FIG. 5 may be performed by a computing device, such as a computer system 800 of FIG. 8, executing the instructions that cause one or more processors to perform operations of the method 500.

The method 500 includes, at 502, processing a portion of time-series data using a trained encoder network to generate a dimensionally reduced encoding of the portion of the time-series data. For example, the encoder network 112 of FIGS. 1 and 2 may generate the dimensionally reduced encoding 116 representing the input data 108 that is based on the time-series data 104.

The method 500 includes, at 504, processing the dimensionally reduced encoding using a trained decoder network to determine decoder output data. For example, the decoder network 118 of FIGS. 1 and 2 may process the dimensionally reduced encoding 116 to generate the decoder output data 120.

The method 500 includes, at 506, setting parameters of a predictive machine-learning model based on the decoder output data, where the predictive machine-learning model is configured to, based on the parameters, determine a predicted future value of the time-series data. For example, the parameters 124 (e.g., the link weights 126) of the predictive machine-learning model 122 may be set based on the decoder output data 120. In this example, the predictive machine-learning model 122 may use the parameters 124 set based on the decoder output data 120 to predict a future value (e.g., the predicted future value 128) of the time series.

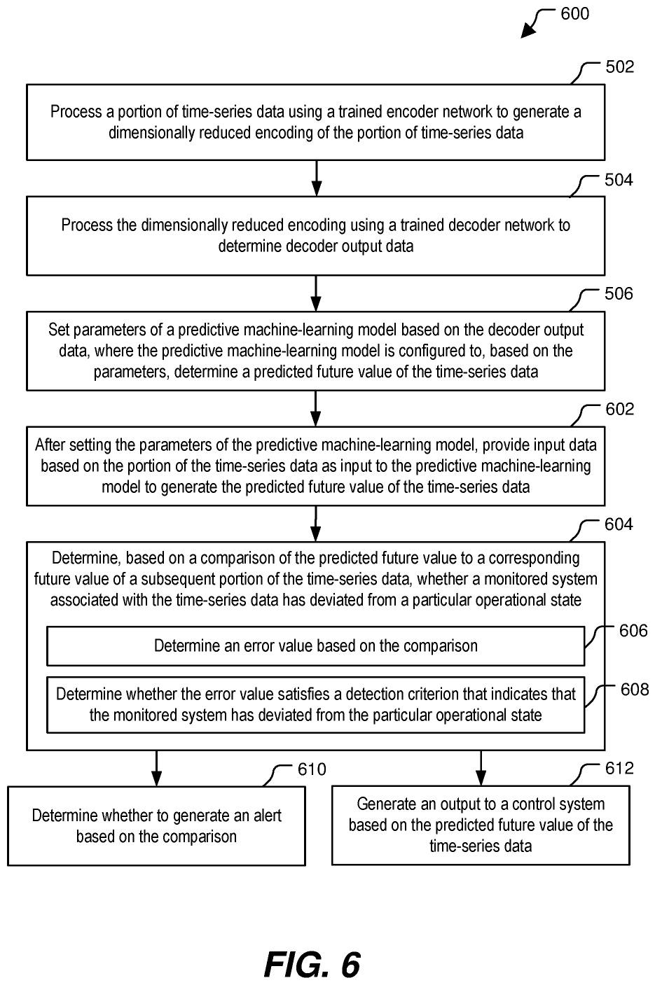

FIG. 6 is a flow chart of a second example of a method 600 of behavior monitoring that may be implemented by the system of FIG. 1 or FIG. 2. For example, one or more operations described with reference to FIG. 6 may be performed by a computing device, such as a computer system 800 of FIG. 8, executing the instructions that cause one or more processors to perform operations of the method 600. The method 600 includes operations described with reference to the method 500 of FIG. 5 as well as additional operations, at least some of which are optional in various implementations.

The method 600 includes, at 502, processing a portion of time-series data using a trained encoder network to generate a dimensionally reduced encoding of the portion of the time-series data. For example, the encoder network 112 of FIGS. 1 and 2 may generate the dimensionally reduced encoding 116 representing the input data 108 that is based on the time-series data 104.

The method 600 includes, at 504, processing the dimensionally reduced encoding using a trained decoder network to determine decoder output data. For example, the decoder network 118 of FIGS. 1 and 2 may process the dimensionally reduced encoding 116 to generate the decoder output data 120.

The method 600 includes, at 506, setting parameters of a predictive machine-learning model based on the decoder output data, where the predictive machine-learning model is configured to, based on the parameters, determine a predicted future value of the time-series data. For example, link weights (e.g., the link weights 126) of the predictive machine-learning model 122 may be set based on the decoder output data 120.

The method 600 also includes, at 602, after setting the parameters of the predictive machine-learning model, providing input data based on the portion of the time-series data as input to the predictive machine-learning model to generate the predicted future value of the time-series data. For example, the predictive machine-learning model 122 of FIGS. 1 and 2 is configured to use the input data 108 and the parameters 124 to predict one or more future values of a times series.

The method 600 further includes, at 604, determining, based on a comparison of the predicted future value to a corresponding future value of a subsequent portion of the time-series data, whether a monitored system associated with the time-series data has deviated from a particular operational state. For example, the alert generator 130 of FIGS. 1 and 2 is configured to receive a subsequent portion of the time-series data 104, where the subsequent portion includes one or more data values corresponding to the predicted future value(s) 128. In this example, the alert generator 130 is configured to compare the subsequent portion of the time-series data 104 and the predicted future value(s) 128 to determine whether the monitored system 102 has deviated from a particular operating state (e.g., has entered an anomalous operating state).

In a particular aspect, determining whether the monitored system has deviated from the particular operational state includes, at 606, determining an error value based on the comparison of the predicted future value to a corresponding future value of a subsequent portion of the time-series data, and at 608, determining whether the error value satisfies a detection criterion that indicates that the monitored system has deviated from the particular operational state. For example, the residual generator 304 of FIG. 3 is configured to generate the residual value(s) 306 based on a comparison of one or more values of the time-series data 104 and one or more predicted future values 128. In this example, the anomaly score calculator 308 determines an anomaly score 310 based on the residual value(s) 306, and the alert generation model 312 compares statistical data 316 based on the anomaly score 310 to reference anomaly scores 320 using a sequential probability ratio test 318 to determine whether the monitored system has deviated from the particular operational state.

In some implementations, the method 600 includes, at 610, determining whether to generate an alert based on the comparison. For example, the alert generation model 312 determines whether to generate the alert 322 based on a result of the sequential probability ratio test 318. In a particular implementation, the alert 322 may be included with other output that is sent to a display. In such implementations, the output may also include a display including an indication of the predicted future value of the time-series data, an indication of an inferred operating state of a monitored system, or both.

In the same or different implementations, the method 600 includes, at 612, generating an output to a control system based on the predicted future value of the time-series data. For example, the alert generator 130 of FIGS. 1-3 may send the output to the control system 134. In this example, the control system 134 may be configured to control aspects of operation of the monitored system 102 and may send one or more control signals to the monitored system 102 responsive to the output from the alert generator 130.

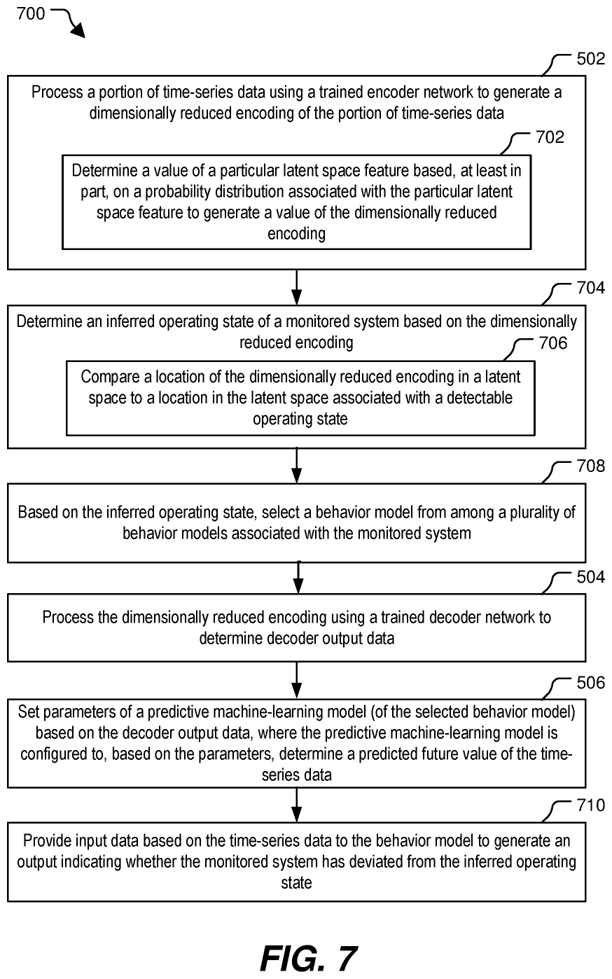

FIG. 7 is a flow chart of a third example of a method 700 of behavior monitoring that may be implemented by the system of FIG. 1 or FIG. 2. For example, one or more operations described with reference to FIG. 7 may be performed by a computing device, such as a computer system 800 of FIG. 8, executing the instructions that cause one or more processors to perform operations of the method 700. The method 700 includes operations described with reference to the method 500 of FIG. 5 as well as additional operations, at least some of which are optional in various implementations.

The method 700 includes, at 502, processing a portion of time-series data using a trained encoder network to generate a dimensionally reduced encoding of the portion of the time-series data. For example, the encoder network 112 of FIGS. 1 and 2 may generate the dimensionally reduced encoding 116 representing the input data 108 that is based on the time-series data 104.

In the example illustrated in FIG. 7, processing a portion of time-series data using a trained encoder network includes, at 702, determining a value of a particular latent-space feature based, at least in part, on a probability distribution associated with the particular latent-space feature to generate a value of the dimensionally reduced encoding. For example, as explained with reference to FIG. 1, the dimensional-reduction model 110 may include or correspond to a probability-based dimensional-reduction model that determines a probability distribution of latent space variables and samples from the probability distribution(s) to generate data provided to the decoder network 118, to the latent-space feature model 202, or both.

The method 700 also includes, at 704, determining an inferred operating state of a monitored system based on the dimensionally reduced encoding. For example, the dimensionally reduced encoding 116 of FIG. 2 may be provided as input to the latent-space feature model 202. In this example, the latent-space feature model 202 may generate as output an inferred operating state 204 of the monitored system 102 based on the dimensionally reduced encoding 116.

In some implementations, determining the inferred operating state of the monitored system includes, at 706, comparing a location in the latent space of the dimensionally reduced encoding to a location associated with a detectable operating state. To illustrate, the location in the latent space associated with the detectable operating state may correspond to or be represented by a boundary of a cluster of points representing the detectable operating state or to a representative location of the cluster of points. In this illustrative example, the points of the cluster of points correspond to other locations in the latent space that are associated with the detectable operating state. In such implementations, comparing the location of the dimensionally reduced encoding to the location in the latent space associated with the detectable operating state may include, for example, determining whether a distance between the location of the dimensionally reduced encoding and the location in the latent space associated with the detectable operating state satisfies a distance threshold. For example, if the location of the dimensionally reduced encoding is within the distance threshold of the location in the latent space associated with the detectable operating state, then the latent-space feature model 202 may determine that the monitored system 102 is operating in the detectable operating state.

In some implementations, the method 700 also includes, at 708, based on the inferred operating state, selecting a behavior model from among a plurality of behavior models associated with the monitored system. For example, the model selector 206 of FIG. 2 may select a particular behavior model 210 from a set of multiple behavior models 208. The particular behavior model 210 selected may be trained to predict future values of the time-series data when the monitored system 102 is in a particular operating state (e.g., the inferred operating state 204) or is in one of a group of operating states that includes the inferred operating state.

The method 700 also includes, at 504, processing the dimensionally reduced encoding using a trained decoder network to determine decoder output data. For example, the decoder network 118 of FIGS. 1 and 2 may process the dimensionally reduced encoding 116 to generate the decoder output data 120.

The method 700 further includes, at 506, setting parameters of a predictive machine-learning model (of the selected behavior model) based on the decoder output data, where the predictive machine-learning model is configured to, based on the parameters, determine a predicted future value of the time-series data. For example, the parameters 124 (e.g., the link weights 126) of the predictive machine-learning model 122 may be set based on the decoder output data 120. In this example, the predictive machine-learning model 122 may use the parameters 124 set based on the decoder output data 120 to predict a future value (e.g., the predicted future value 128) of the time series.

The method 700 of FIG. 7 also includes, at 710, providing input data based on the time-series data to the selected behavior model to generate an output indicating whether the monitored system has deviated from the inferred operating state. For example, the input data 108 of FIG. 2 may be provided to the predictive machine-learning model 122 of the selected behavior model 210 to generate the predicted future value(s) 128. In this example, the predicted future value(s) 128 are provided to the alert generator 130 of the selected behavior model 210 and the alert generator 130 generates output indicating whether the monitored system 102 has deviated from the inferred operating state 204.

Thus, the methods described herein use two or more machine-learning models in a manner that provides more accurate detection of changes or anomalies in an operating state of the monitored system. Additionally, in some implementations, the method 500, the method 600, and/or the method 700 may improve the situational awareness of operators of the monitored system, such as by providing output identifying an inferred operating state of the monitored system along with alerting information if the monitored system deviates from a particular operating state.

FIG. 8 illustrates an example of a computer system 800 corresponding to, including, or included within the system 100 of FIG. 1 or the system 200 of FIG. 2 according to particular implementations. For example, the computer system 800 is configured to initiate, perform, or control one or more of the operations described with reference to FIGS. 1-7. The computer system 800 can be implemented as or incorporated into one or more of various other devices, such as a personal computer (PC), a tablet PC, a server computer, a personal digital assistant (PDA), a laptop computer, a desktop computer, a communications device, a wireless telephone, or any other machine capable of executing a set of instructions (sequential or otherwise) that specify actions to be taken by that machine. Further, while a single computer system 800 is illustrated, the term “system” includes any collection of systems or sub-systems that individually or jointly execute a set, or multiple sets, of instructions to perform one or more computer functions.

While FIG. 8 illustrates one example of the computer system 800, other computer systems or computing architectures and configurations may be used for carrying out the monitoring operations disclosed herein. The computer system 800 includes the one or more processors 810. Each processor of the one or more processors 810 can include a single processing core or multiple processing cores that operate sequentially, in parallel, or sequentially at times and in parallel at other times. Each processor of the one or more processors 810 includes circuitry defining a plurality of logic circuits 812, working memory 814 (e.g., registers and cache memory), communication circuits, etc., which together enable the processor(s) 810 to control the operations performed by the computer system 800 and enable the processor(s) 810 to generate a useful result based on analysis of particular data and execution of specific instructions.

The processor(s) 810 are configured to interact with other components or subsystems of the computer system 800 via a bus 870. The bus 870 is illustrative of any interconnection scheme serving to link the subsystems of the computer system 800, external subsystems or devices, or any combination thereof. The bus 870 includes a plurality of conductors to facilitate communication of electrical and/or electromagnetic signals between the components or subsystems of the computer system 800. Additionally, the bus 870 includes one or more bus controllers or other circuits (e.g., transmitters and receivers) that manage signaling via the plurality of conductors and that cause signals sent via the plurality of conductors to conform to particular communication protocols.

The computer system 800 also includes the one or more memory devices 850. The memory device(s) 850 include any suitable computer-readable storage device depending on, for example, whether data access needs to be bi-directional or unidirectional, speed of data access required, memory capacity required, other factors related to data access, or any combination thereof. Generally, the memory device(s) 850 includes some combinations of volatile memory devices and non-volatile memory devices, though in some implementations, only one or the other may be present. Examples of volatile memory devices and circuits include registers, caches, latches, many types of random-access memory (RAM), such as dynamic random-access memory (DRAM), etc. Examples of non-volatile memory devices and circuits include hard disks, optical disks, flash memory, and certain types of RAM, such as resistive random-access memory (ReRAM). Other examples of both volatile and non-volatile memory devices can be used as well, or in the alternative, so long as such memory devices store information in a physical, tangible medium. Thus, the memory device(s) 850 include circuits and structures and are not merely signals or other transitory phenomena (i.e., are non-transitory media).

In the example illustrated in FIG. 8, the memory device(s) 850 store the instructions 852 that are executable by the processor(s) 810 to perform various operations and functions. The instructions 852 include instructions to enable the various components and subsystems of the computer system 800 to operate, interact with one another, and interact with a user, such as a basic input/output system (BIOS) 854 and an operating system (OS) 856. Additionally, the instructions 852 include one or more applications 858, scripts, or other program code to enable the processor(s) 810 to perform the operations described herein. For example, in FIG. 8, the instructions 852 include instructions configured to initiate, control, or perform the preprocessor 106 of FIGS. 1 and 2, and one or more models 860, such as the dimensional-reduction model 110 and/or one or more of the multiple behavior models 208.

In FIG. 8, the computer system 800 also includes one or more of the output device(s) 132, one or more input devices 820, and one or more interface devices 840. Each of the output device(s) 132, the input device(s) 820, and the interface device(s) 840 can be coupled to the bus 870 via a port or connector, such as a Universal Serial Bus port, a digital visual interface (DVI) port, a serial ATA (SATA) port, a small computer system interface (SCSI) port, a high-definition media interface (HDMI) port, or another serial or parallel port. In some implementations, one or more of the output device(s) 132, the input device(s) 820, and/or the interface device(s) 840 is coupled to or integrated within a housing with the processor(s) 810 and the memory device(s) 850, in which case the connections to the bus 870 can be internal, such as via an expansion slot or other card-to-card connector. In other implementations, the processor(s) 810 and the memory device(s) 850 are integrated within a housing that includes one or more external ports, and one or more of the output device(s) 132, the input device(s) 820, and/or the interface device(s) 840 is coupled to the bus 870 via the external port(s).

Examples of the output device(s) 132 include a display 832, speakers, printers, televisions, projectors, or other devices to provide output of data in a manner that is perceptible by a user. In a particular example, the display 832 may be configured to output a graphical user interface (GUI) 834 that includes information such as the alert 322, the inferred operating state 204, a confidence value associated with the inferred operating state 204, etc. Examples of the input device(s) 820 include buttons, switches, knobs, a keyboard 822, a pointing device 824, a biometric device, a microphone, a motion sensor, or another device to detect user input actions. The pointing device 824 includes, for example, one or more of a mouse, a stylus, a track ball, a pen, a touch pad, a touch screen, a tablet, another device that is useful for interacting with a graphical user interface, or any combination thereof. A particular device may be an input device 820 and an output device 132. For example, the particular device may be a touch screen.

The interface device(s) 840 are configured to enable the computer system 800 to communicate with one or more other devices 844 directly or via one or more networks 842. For example, the interface device(s) 840 may encode data in electrical and/or electromagnetic signals that are transmitted to the other device(s) 844 as control signals or packet-based communication using pre-defined communication protocols. As another example, the interface device(s) 840 may receive and decode electrical and/or electromagnetic signals that are transmitted by the other device(s) 844. To illustrate, the other device(s) 844 may include the monitored system 102, the control system 134, or both. The electrical and/or electromagnetic signals can be transmitted wirelessly (e.g., via propagation through free space), via one or more wires, cables, optical fibers, or via a combination of wired and wireless transmission.

In an alternative embodiment, dedicated hardware implementations, such as application specific integrated circuits, programmable logic arrays and other hardware devices, can be constructed to implement one or more of the operations described herein. Accordingly, the present disclosure encompasses software, firmware, and hardware implementations.

The systems and methods illustrated herein may be described in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may be embodied as a customization of an existing system, an add-on product, a processing apparatus executing upgraded software, a standalone system, a distributed system, a method, a data processing system, a device for data processing, and/or a computer program product. Accordingly, any portion of the system or a module or a decision model may take the form of a processing apparatus executing code, an internet based (e.g., cloud computing) embodiment, an entirely hardware embodiment, or an embodiment combining aspects of the internet, software, and hardware. Furthermore, the system may take the form of a computer program product on a computer-readable storage medium or device having computer-readable program code (e.g., instructions) embodied or stored in the storage medium or device. Any suitable computer-readable storage medium or device may be utilized, including hard disks, CD-ROM, optical storage devices, magnetic storage devices, and/or other storage media. As used herein, a “computer-readable storage medium” or “computer-readable storage device” is not a signal.

Systems and methods may be described herein with reference to screen shots, block diagrams and flowchart illustrations of methods, apparatuses (e.g., systems), and computer media according to various aspects. It will be understood that each functional block of a block diagrams and flowchart illustration, and combinations of functional blocks in block diagrams and flowchart illustrations, respectively, can be implemented by computer program instructions.

Computer program instructions may be loaded onto a computer or other programmable data processing apparatus to produce a machine, such that the instructions that execute on the computer or other programmable data processing apparatus create means for implementing the functions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Particular aspects of the disclosure are described below in the following examples:

Example 1 includes a device including one or more processors configured to: process a portion of time-series data using a trained encoder network to generate a dimensionally reduced encoding of the portion of the time-series data; process the dimensionally reduced encoding using a trained decoder network to determine decoder output data; and set parameters of a predictive machine-learning model based on the decoder output data, wherein the predictive machine-learning model is configured to, based on the parameters, determine a predicted future value of the time-series data.

Example 2 includes the device of Example 1, wherein the one or more processors are further configured to, after setting the parameters of the predictive machine-learning model, provide input data based on the portion of the time-series data as input to the predictive machine-learning model to generate the predicted future value of the time-series data.

Example 3 includes the device of Example 1 or the device of Example 2, wherein the one or more processors are further configured to: receive a subsequent portion of the time-series data; and determine, based on a comparison of the predicted future value to a corresponding future value of the subsequent portion of the time-series data, whether a monitored system associated with the time-series data has deviated from a particular operational state.

Example 4 includes the device of Example 3, wherein determining whether the monitored system has deviated from the particular operational state includes: determining an error value based on the comparison; and determining whether the error value satisfies a detection criterion that indicates that the monitored system has deviated from the particular operational state.

Example 5 includes the device of Example 3 or the device of Example 4, wherein the one or more processors are further configured to determine whether to generate an alert based on the comparison.

Example 6 includes any of the devices of Examples 1 to 5, wherein the predictive machine-learning model includes a neural network, and wherein setting the parameters of the predictive machine-learning model includes setting a link weight of the neural network to a value indicated by the decoder output data.

Example 7 includes any of the devices of Examples 1 to 6, wherein the trained encoder network, the trained decoder network, and the predictive machine-learning model are trained together based on training data associated with a monitored system.

Example 8 includes any of the devices of Examples 1 to 7, wherein the one or more processors are further configured to generate an output to a control system based on the predicted future value of the time-series data.

Example 9 includes the device of Example 8, wherein the output includes a control signal to modify operation associated with a monitored system.

Example 10 includes the device of Example 8 or the device of Example 9, wherein the output includes a display including an indication of the predicted future value of the time-series data, an indication of an inferred operating state of a monitored system, or both.

Example 11 includes any of the devices of Examples 1 to 10, wherein processing the portion of the time-series data using the trained encoder network includes determining a value of a particular latent-space feature based, at least in part, on a probability distribution associated with the particular latent-space feature to generate a value of the dimensionally reduced encoding.

Example 12 includes any of the devices of Examples 1 to 11, wherein the one or more processors are further configured to: determine an inferred operating state of a monitored system based on the dimensionally reduced encoding; based on the inferred operating state, select a behavior model from among a plurality of behavior models associated with the monitored system; and provide input data based on the time-series data to the behavior model to generate an output indicating whether the monitored system has deviated from the inferred operating state.

Example 13 includes the device of Example 12, wherein determining the inferred operating state of the monitored system includes comparing a location of the dimensionally reduced encoding in a latent space to a location in the latent space associated with a detectable operating state.

Example 14 includes the device of Example 13, wherein the location in the latent space associated with the detectable operating state corresponds to a boundary of a cluster of points representing the detectable operating state or to a representative location of the cluster of points.

Example 15 includes the device of Example 13 or the device of Example 14, wherein comparing the location of the dimensionally reduced encoding to the location in the latent space associated with the detectable operating state includes determining whether a distance between the location of the dimensionally reduced encoding and the location in the latent space associated with the detectable operating state satisfies a distance threshold.

Example 16 includes a method that includes: processing a portion of time-series data using a trained encoder network to generate a dimensionally reduced encoding of the portion of the time-series data; processing the dimensionally reduced encoding using a trained decoder network to determine decoder output data; and setting parameters of a predictive machine-learning model based on the decoder output data, wherein the predictive machine-learning model is configured to, based on the parameters, determine a predicted future value of the time-series data.

Example 17 includes the method of Example 16, further including, after setting the parameters of the predictive machine-learning model, providing input data based on the portion of the time-series data as input to the predictive machine-learning model to generate the predicted future value of the time-series data.

Example 18 includes the method of Example 16 or the method of Example 17, further including: receiving a subsequent portion of the time-series data; and determining, based on a comparison of the predicted future value to a corresponding future value of the subsequent portion of the time-series data, whether a monitored system associated with the time-series data has deviated from a particular operational state.

Example 19 includes the method of Example 18, wherein determining whether the monitored system has deviated from the particular operational state includes: determining an error value based on the comparison; and determining whether the error value satisfies a detection criterion that indicates that the monitored system has deviated from the particular operational state.

Example 20 includes the method of Example 18 or the method of Example 19, further including determining whether to generate an alert based on the comparison.

Example 21 includes any of the methods of Examples 16 to 20, wherein the predictive machine-learning model includes a neural network, and wherein setting the parameters of the predictive machine-learning model includes setting a link weight of the neural network to a value indicated by the decoder output data.

Example 22 includes any of the methods of Examples 16 to 21, wherein the trained encoder network, the trained decoder network, and the predictive machine-learning model are trained together based on training data associated with a monitored system.

Example 23 includes any of the methods of Examples 16 to 22, further including generating an output to a control system based on the predicted future value of the time-series data.

Example 24 includes the method of Example 23, wherein the output includes a control signal to modify operation associated with a monitored system.

Example 25 includes the method of Example 23 or the method of Example 24, wherein the output includes a display including an indication of the predicted future value of the time-series data, an indication of an inferred operating state of a monitored system, or both.

Example 26 includes any of the methods of Examples 16 to 25, wherein processing the portion of the time-series data using the trained encoder network includes determining a value of a particular latent-space feature based, at least in part, on a probability distribution associated with the particular latent-space feature to generate a value of the dimensionally reduced encoding.

Example 27 includes any of the methods of Examples 16 to 26, further including: determining an inferred operating state of a monitored system based on the dimensionally reduced encoding; based on the inferred operating state, selecting a behavior model from among a plurality of behavior models associated with the monitored system; and providing input data based on the time-series data to the behavior model to generate an output indicating whether the monitored system has deviated from the inferred operating state.

Example 28 includes the method of Example 27, wherein determining the inferred operating state of the monitored system includes comparing a location of the dimensionally reduced encoding in a latent space to a location in the latent space associated with a detectable operating state.

Example 29 includes the method of Example 28, wherein the location in the latent space associated with the detectable operating state corresponds to a boundary of a cluster of points representing the detectable operating state or to a representative location of the cluster of points.

Example 30 includes the method of Example 28 or the method of Example 29, wherein comparing the location of the dimensionally reduced encoding to the location in the latent space associated with the detectable operating state includes determining whether a distance between the location of the dimensionally reduced encoding and the location in the latent space associated with the detectable operating state satisfies a distance threshold.

Example 31 includes a computer-readable storage device storing instructions that are executable by one or more processors to cause the one or more processors to perform operations including: processing a portion of time-series data using a trained encoder network to generate a dimensionally reduced encoding of the portion of the time-series data; processing the dimensionally reduced encoding using a trained decoder network to determine decoder output data; and setting parameters of a predictive machine-learning model based on the decoder output data, wherein the predictive machine-learning model is configured to, based on the parameters, determine a predicted future value of the time-series data.

Example 32 includes the computer-readable storage device of Example 31, wherein the operations further include, after setting the parameters of the predictive machine-learning model, providing input data based on the portion of the time-series data as input to the predictive machine-learning model to generate the predicted future value of the time-series data.

Example 33 includes the computer-readable storage device of Example 31 or the computer-readable storage device of Example 32, wherein the operations further include: receiving a subsequent portion of the time-series data; and determining, based on a comparison of the predicted future value to a corresponding future value of the subsequent portion of the time-series data, whether a monitored system associated with the time-series data has deviated from a particular operational state.

Example 34 includes the computer-readable storage device of Example 33, wherein determining whether the monitored system has deviated from the particular operational state includes: determining an error value based on the comparison; and determining whether the error value satisfies a detection criterion that indicates that the monitored system has deviated from the particular operational state.

Example 35 includes the computer-readable storage device of Example 33 or the computer-readable storage device of Example 34, wherein the operations further include determining whether to generate an alert based on the comparison.

Example 36 includes the computer-readable storage device of any of Examples 31 to 35, wherein the predictive machine-learning model includes a neural network, and wherein setting the parameters of the predictive machine-learning model includes setting a link weight of the neural network to a value indicated by the decoder output data.

Example 37 includes the computer-readable storage device of any of Examples 31 to 36, wherein the trained encoder network, the trained decoder network, and the predictive machine-learning model are trained together based on training data associated with a monitored system.

Example 38 includes the computer-readable storage device of any of Examples 31 to 37, wherein the operations further include generating an output to a control system based on the predicted future value of the time-series data.

Example 39 includes the computer-readable storage device of Example 38, wherein the output includes a control signal to modify operation associated with a monitored system.

Example 40 includes the computer-readable storage device of Example 38 or the computer-readable storage device of Example 39, wherein the output includes a display including an indication of the predicted future value of the time-series data, an indication of an inferred operating state of a monitored system, or both.

Example 41 includes the computer-readable storage device of any of Examples 31 to 40, wherein processing the portion of the time-series data using the trained encoder network includes determining a value of a particular latent-space feature based, at least in part, on a probability distribution associated with the particular latent-space feature to generate a value of the dimensionally reduced encoding.

Example 42 includes the computer-readable storage device of any of Examples 31 to 41, wherein the operations further include: determining an inferred operating state of a monitored system based on the dimensionally reduced encoding; based on the inferred operating state, selecting a behavior model from among a plurality of behavior models associated with the monitored system; and providing input data based on the time-series data to the behavior model to generate an output indicating whether the monitored system has deviated from the inferred operating state.

Example 43 includes the computer-readable storage device of Example 42, wherein determining the inferred operating state of the monitored system includes comparing a location of the dimensionally reduced encoding in a latent space to a location in the latent space associated with a detectable operating state.

Example 44 includes the computer-readable storage device of Example 43, wherein the location in the latent space associated with the detectable operating state corresponds to a boundary of a cluster of points representing the detectable operating state or to a representative location of the cluster of points.

Example 45 includes the computer-readable storage device of Example 43 of the computer-readable storage device of Example 44, wherein comparing the location of the dimensionally reduced encoding to the location in the latent space associated with the detectable operating state includes determining whether a distance between the location of the dimensionally reduced encoding and the location in the latent space associated with the detectable operating state satisfies a distance threshold.

Although the disclosure may include one or more methods, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

What is claimed is:

1. A device comprising:
one or more processors configured to:
process a portion of time-series data using a trained encoder network to generate a dimensionally reduced encoding of the portion of the time-series data;
process the dimensionally reduced encoding using a trained decoder network to determine decoder output data; and
set parameters of a predictive machine-learning model based on the decoder output data, wherein the predictive machine-learning model is configured to, based on the parameters, determine a predicted future value of the time-series data.

2. The device of claim 1, wherein the one or more processors are further configured to, after setting the parameters of the predictive machine-learning model, provide input data based on the portion of the time-series data as input to the predictive machine-learning model to generate the predicted future value of the time-series data.

3. The device of claim 1, wherein the one or more processors are further configured to:
receive a subsequent portion of the time-series data; and
determine, based on a comparison of the predicted future value to a corresponding future value of the subsequent portion of the time-series data, whether a monitored system associated with the time-series data has deviated from a particular operational state.

4. The device of claim 3, wherein determining whether the monitored system has deviated from the particular operational state comprises:
determining an error value based on the comparison; and
determining whether the error value satisfies a detection criterion that indicates that the monitored system has deviated from the particular operational state.

5. The device of claim 3, wherein the one or more processors are further configured to determine whether to generate an alert based on the comparison.

6. The device of claim 1, wherein the predictive machine-learning model includes a neural network, and wherein setting the parameters of the predictive machine-learning model includes setting a link weight of the neural network to a value indicated by the decoder output data.

7. The device of claim 1, wherein the trained encoder network, the trained decoder network, and the predictive machine-learning model are trained together based on training data associated with a monitored system.

8. The device of claim 1, wherein the one or more processors are further configured to generate an output to a control system based on the predicted future value of the time-series data.

9. The device of claim 8, wherein the output includes a control signal to modify operation associated with a monitored system.

10. The device of claim 8, wherein the output includes a display including an indication of the predicted future value of the time-series data, an indication of an inferred operating state of a monitored system, or both.

11. The device of claim 1, wherein processing the portion of the time-series data using the trained encoder network includes determining a value of a particular latent-space feature based, at least in part, on a probability distribution associated with the particular latent-space feature to generate a value of the dimensionally reduced encoding.

12. The device of claim 1, wherein the one or more processors are further configured to:
determine an inferred operating state of a monitored system based on the dimensionally reduced encoding;
based on the inferred operating state, select a behavior model from among a plurality of behavior models associated with the monitored system; and
provide input data based on the time-series data to the behavior model to generate an output indicating whether the monitored system has deviated from the inferred operating state.

13. The device of claim 12, wherein determining the inferred operating state of the monitored system includes comparing a location of the dimensionally reduced encoding in a latent space to a location in the latent space associated with a detectable operating state.

14. The device of claim 13, wherein the location in the latent space associated with the detectable operating state corresponds to a boundary of a cluster of points representing the detectable operating state or to a representative location of the cluster of points.

15. The device of claim 13, wherein comparing the location of the dimensionally reduced encoding to the location in the latent space associated with the detectable operating state comprises determining whether a distance between the location of the dimensionally reduced encoding and the location in the latent space associated with the detectable operating state satisfies a distance threshold.

16. A method comprising:
processing a portion of time-series data using a trained encoder network to generate a dimensionally reduced encoding of the portion of the time-series data;
processing the dimensionally reduced encoding using a trained decoder network to determine decoder output data; and
setting parameters of a predictive machine-learning model based on the decoder output data, wherein the predictive machine-learning model is configured to, based on the parameters, determine a predicted future value of the time-series data.

17. The method of claim 16, further comprising, after setting the parameters of the predictive machine-learning model, providing input data based on the portion of the time-series data as input to the predictive machine-learning model to generate the predicted future value of the time-series data.

18. The method of claim 16, further comprising:
receiving a subsequent portion of the time-series data; and
determining, based on a comparison of the predicted future value to a corresponding future value of the subsequent portion of the time-series data, whether a monitored system associated with the time-series data has deviated from a particular operational state.

19. The method of claim 18, wherein determining whether the monitored system has deviated from the particular operational state comprises:
determining an error value based on the comparison; and
determining whether the error value satisfies a detection criterion that indicates that the monitored system has deviated from the particular operational state.

20. The method of claim 18, further comprising determining whether to generate an alert based on the comparison.

21. The method of claim 16, wherein the predictive machine-learning model includes a neural network, and wherein setting the parameters of the predictive machine-learning model includes setting a link weight of the neural network to a value indicated by the decoder output data.

22. The method of claim 16, wherein the trained encoder network, the trained decoder network, and the predictive machine-learning model are trained together based on training data associated with a monitored system.

23. The method of claim 16, further comprising generating an output to a control system based on the predicted future value of the time-series data.

24. The method of claim 23, wherein the output includes a control signal to modify operation associated with a monitored system.

25. The method of claim 23, wherein the output includes a display including an indication of the predicted future value of the time-series data, an indication of an inferred operating state of a monitored system, or both.

26. The method of claim 16, wherein processing the portion of the time-series data using the trained encoder network includes determining a value of a particular latent-space feature based, at least in part, on a probability distribution associated with the particular latent-space feature to generate a value of the dimensionally reduced encoding.

27. The method of claim 16, further comprising:
determining an inferred operating state of a monitored system based on the dimensionally reduced encoding;
based on the inferred operating state, selecting a behavior model from among a plurality of behavior models associated with the monitored system; and
providing input data based on the time-series data to the behavior model to generate an output indicating whether the monitored system has deviated from the inferred operating state.

28. The method of claim 27, wherein determining the inferred operating state of the monitored system includes comparing a location of the dimensionally reduced encoding in a latent space to a location in the latent space associated with a detectable operating state.

29. The method of claim 28, wherein the location in the latent space associated with the detectable operating state corresponds to a boundary of a cluster of points representing the detectable operating state or to a representative location of the cluster of points.

30. The method of claim 28, wherein comparing the location of the dimensionally reduced encoding to the location in the latent space associated with the detectable operating state comprises determining whether a distance between the location of the dimensionally reduced encoding and the location in the latent space associated with the detectable operating state satisfies a distance threshold.

31. A computer-readable storage device storing instructions that are executable by one or more processors to cause the one or more processors to perform operations comprising:
processing a portion of time-series data using a trained encoder network to generate a dimensionally reduced encoding of the portion of the time-series data;
processing the dimensionally reduced encoding using a trained decoder network to determine decoder output data; and
setting parameters of a predictive machine-learning model based on the decoder output data, wherein the predictive machine-learning model is configured to, based on the parameters, determine a predicted future value of the time-series data.

32. The computer-readable storage device of claim 31, wherein the operations further comprise, after setting the parameters of the predictive machine-learning model, providing input data based on the portion of the time-series data as input to the predictive machine-learning model to generate the predicted future value of the time-series data.

33. The computer-readable storage device of claim 31, wherein the operations further comprise:
receiving a subsequent portion of the time-series data; and
determining, based on a comparison of the predicted future value to a corresponding future value of the subsequent portion of the time-series data, whether a monitored system associated with the time-series data has deviated from a particular operational state.

34. The computer-readable storage device of claim 33, wherein determining whether the monitored system has deviated from the particular operational state comprises:
determining an error value based on the comparison; and
determining whether the error value satisfies a detection criterion that indicates that the monitored system has deviated from the particular operational state.

35. The computer-readable storage device of claim 33, wherein the operations further comprise determining whether to generate an alert based on the comparison.

36. The computer-readable storage device of claim 31, wherein the predictive machine-learning model includes a neural network, and wherein setting the parameters of the predictive machine-learning model includes setting a link weight of the neural network to a value indicated by the decoder output data.

37. The computer-readable storage device of claim 31, wherein the trained encoder network, the trained decoder network, and the predictive machine-learning model are trained together based on training data associated with a monitored system.

38. The computer-readable storage device of claim 31, wherein the operations further comprise generating an output to a control system based on the predicted future value of the time-series data.

39. The computer-readable storage device of claim 38, wherein the output includes a control signal to modify operation associated with a monitored system.

40. The computer-readable storage device of claim 38, wherein the output includes a display including an indication of the predicted future value of the time-series data, an indication of an inferred operating state of a monitored system, or both.

41. The computer-readable storage device of claim 31, wherein processing the portion of the time-series data using the trained encoder network includes determining a value of a particular latent-space feature based, at least in part, on a probability distribution associated with the particular latent-space feature to generate a value of the dimensionally reduced encoding.

42. The computer-readable storage device of claim 31, wherein the operations further comprise:
determining an inferred operating state of a monitored system based on the dimensionally reduced encoding;
based on the inferred operating state, selecting a behavior model from among a plurality of behavior models associated with the monitored system; and
providing input data based on the time-series data to the behavior model to generate an output indicating whether the monitored system has deviated from the inferred operating state.

43. The computer-readable storage device of claim 42, wherein determining the inferred operating state of the monitored system includes comparing a location of the dimensionally reduced encoding in a latent space to a location in the latent space associated with a detectable operating state.

44. The computer-readable storage device of claim 43, wherein the location in the latent space associated with the detectable operating state corresponds to a boundary of a cluster of points representing the detectable operating state or to a representative location of the cluster of points.

45. The computer-readable storage device of claim 43, wherein comparing the location of the dimensionally reduced encoding to the location in the latent space associated with the detectable operating state comprises determining whether a distance between the location of the dimensionally reduced encoding and the location in the latent space associated with the detectable operating state satisfies a distance threshold.
